(19) United States
(12) Patent Application Publication
(10) Pub. No.: US 2026/0309367 A1
(43) Pub. Date: Oct. 8, 2026

(54) BAFFLE FOR CONDENSING FLUE TUBES WITHIN A WATER HEATING APPLIANCE

(71) Applicant: BRADFORD WHITE CORPORATION, AMBLER, PA (US)

(72) Inventor: Mehran Seyed Ahmadi, Rochester Hills, MI (US)

(73) Assignee: BRADFORD WHITE CORPORATION, AMBLER, PA (US)

(21) Appl. No.: 19/170,697

(22) Filed: Apr. 4, 2025

(51) Int. Cl. F24H 8/00; F24H 1/20

(52) U.S. Cl. CPC F24H 8/00; F24H 1/205

(57) ABSTRACT

A condensing water heater includes a reservoir, a heater and a blower that deliver process air into an airflow path having a sensible heat exchange section and a latent heat exchange section downstream of the sensible heat exchange section. The latent heat exchange section includes condensing tubes in thermal communication with the reservoir. Each condensing tube includes an outer sleeve and inserts positioned therein and having heat exchange obstructions. Each insert has a lever portion at a first edge and a biasing portion at a second edge that opposes the first edge and that engage one another. The biasing portions of the inserts deflect the lever portions of the inserts to generate an outward biasing force that biases each insert against the outer sleeve to eliminate gaps between the inserts and the outer sleeve to direct the heated process air through the heat exchange obstructions.

### FIELD OF THE DISCLOSURE

This disclosure relates to water heaters and, more particularly, to a condensing tube for a water heating appliance that includes an outwardly biased baffle design that presses against an outer sleeve of the condensing tube.

### BACKGROUND OF THE DISCLOSURE

Commercial water heaters typically heat water by generating tens of thousands, and even hundreds of thousands, of BTUs. These appliances utilize gas and electric heaters for producing heated air that is delivered through an air flow path. The heat from the heated air is transferred through a wall of the airflow path and into the water being heated within a reservoir. Certain water heaters include sensible heat exchange areas and latent heat exchange areas for delivering heat from the heated air and into the water being heated.

### SUMMARY OF THE DISCLOSURE

According to an aspect of the present disclosure, a single-pass condensing water heater includes a reservoir that stores water to be heated, a heater and a blower that deliver heated process air into an airflow inlet positioned at an end of the reservoir, a sensible heat exchange section of an airflow path that is attached to the airflow inlet and extends through and is in thermal communication with the reservoir, and a latent heat exchange section of the airflow path that is downstream of the sensible heat exchange area. The latent heat exchange section includes a plurality of condensing tubes in thermal communication with the reservoir. Each condensing tube of the plurality of condensing tubes includes an outer sleeve and a plurality of inserts having heat exchange obstructions defined therein. The plurality of inserts are positioned within the outer sleeve. Each insert has a lever portion at a first edge and a biasing portion at a second edge that opposes the first edge. The lever portion of a first insert of the plurality of inserts respectively engages the biasing portion of an adjacent insert of the plurality of inserts. The biasing portions of the plurality of inserts deflect the lever portions of the plurality of inserts, respectively, within the outer sleeve to generate an outward biasing force that biases an outer surface of each insert of the plurality of inserts against an inner surface of the outer sleeve. The outward biasing force substantially eliminates gaps between the plurality of inserts and the outer sleeve to direct the heated process air through the plurality of heat exchange obstructions.

According to another aspect of the present disclosure, a latent heat exchange section of a single-pass condensing water heater includes at least one condensing tube configured to receive heated process air from a sensible heat exchange section. The at least one condensing tube includes a first heat conductive insert having a first lever portion and a first biasing portion, a second heat conductive insert having a second lever portion and a second biasing portion, and an outer sleeve having an interior that receives the first heat conductive insert and the second heat conductive insert. The first biasing portion engages the second lever portion within the interior of the outer sleeve and generates a first outward biasing force that biases the first heat conductive insert against an inner surface of the outer sleeve. The second biasing portion engages the first lever portion within the interior of the outer sleeve and generates a second outward biasing force that biases the second heat conductive insert against the inner surface of the outer sleeve. The first outward biasing force and the second outward biasing force bias the first and second heat conductive inserts against the inner surface to form a substantially continuous seal between the outer sleeve and the first and second heat conductive inserts.

According to another aspect of the present disclosure, a condensing tube for a single-pass heat exchanger of a water heating appliance includes an outer sleeve having an inner surface that defines a cylindrical interior, a first heat conductive insert having a first central plane, and a second heat conductive insert having a second central plane. The first and second heat conductive inserts each include a first edge and a second edge that opposes the first edge. The first and second heat conductive inserts define an engaged position when the first edge of the first heat conductive insert engages the second edge of the second heat conductive insert and the second edge of the first heat conductive insert engages the first edge of the second heat conductive insert. The engaged position of the first and second heat conductive inserts distal from the outer sleeve is defined by an eccentric configuration wherein the first central plane of the first heat conductive insert is offset from the second central plane of the second heat conductive insert. The engaged position of the first and second heat conductive inserts in an installed state within the outer sleeve is defined by a cylindrical configuration of the first and second heat conductive inserts. Modulation of the first and second heat conductive inserts from the engaged position distal from the outer sleeve to the installed state biases the first central plane to be substantially co-planar with the second central plane. Further, the installed state generates an outward biasing force that biases outer surfaces of the first and second heat conductive inserts against the inner surface of the outer sleeve to form a substantially continuous seal between the outer sleeve and the first and second heat conductive inserts.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevation view of a water heating appliance that incorporates an aspect of the multi-part baffle design for condensing flue tubes;

FIG. 2 is a perspective view of the water heating appliance of FIG. 1;

FIG. 3 is a cross-sectional view of the water heating appliance of FIG. 2, taken along line III-III;

FIG. 4 is an enlarged cross-sectional view of the water heating appliance of FIG. 3, taken at area IV;

FIG. 5 is an exploded perspective view of a latent heat exchange section of a water heating appliance that incorporates an aspect of the multi-part baffle design for the condensing flue tubes;

FIG. 6 is a cross-sectional view of the water heating appliance of FIG. 4, taken along line VI-VI;

FIG. 7 is a cross-sectional view of an aspect of the condensing flue tubes and having the multi-part baffle design disposed therein;

FIG. 8 is an exploded perspective view of the condensing flue tube of FIG. 7;

FIG. 9 is a cross-sectional view of an aspect of the multi-component baffle design for the condensing flue tube, and showing the inserts in an engaged position outside of the outer sleeve and indicative of an eccentric configuration of the inserts;

FIG. 10 is a schematic diagram illustrating movement of the inserts from the eccentric configuration to the cylindrical configuration that produces the outward biasing forces of the inserts against the outer sleeve;

FIG. 11 is a cross-sectional view of the heat exchange tube of FIG. 7 taken along line XI-XI, and showing the inserts in the cylindrical configuration that produces the outward biasing forces;

FIG. 12 is an enlarged cross-sectional view of the condensing flue tube of FIG. 11, taken at area XII; and

FIG. 13 is a schematic diagram illustrating modulation of a plurality of heat exchange inserts from an eccentric configuration to a cylindrical configuration.

The components in the figures are not necessarily to scale, emphasis instead being placed upon illustrating the principles described herein.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

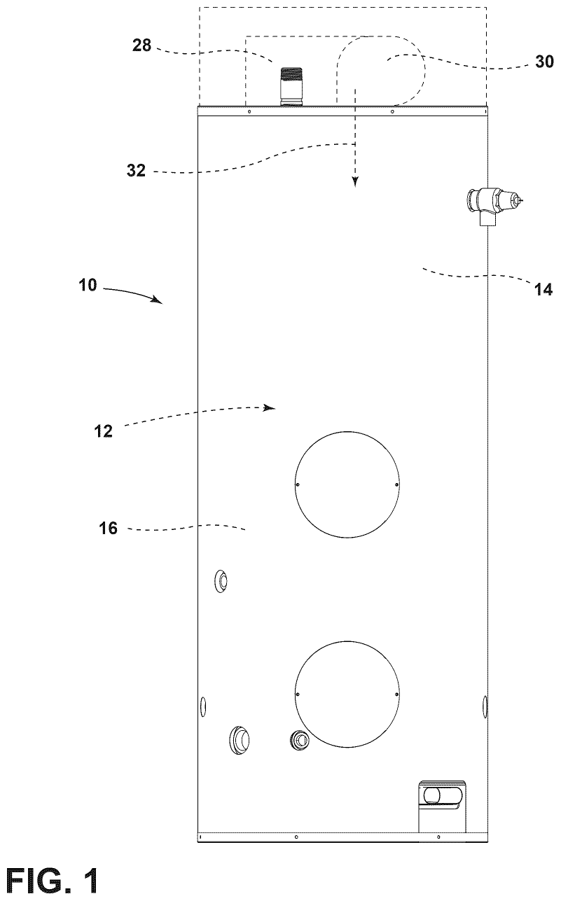

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a baffle for condensing flue tubes within a latent heat exchange section of a water heating appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises. a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

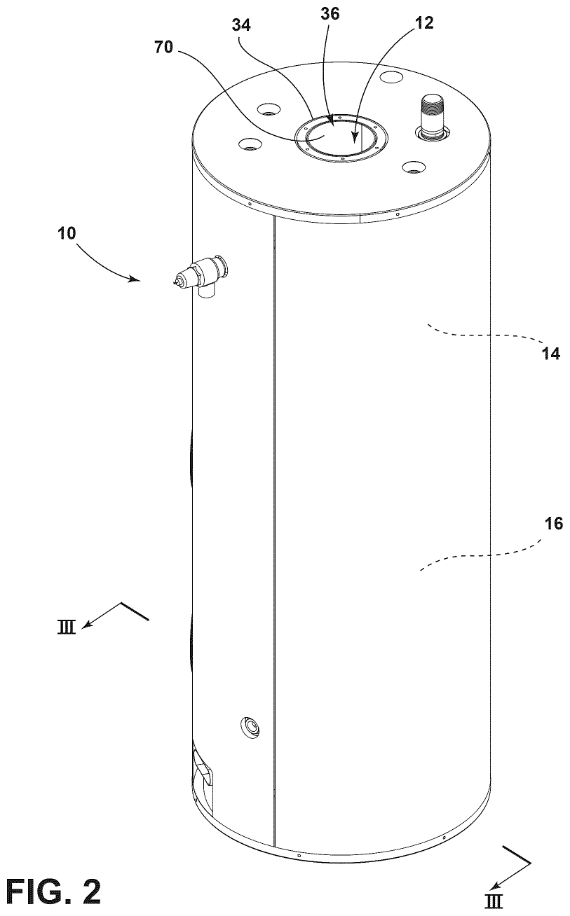

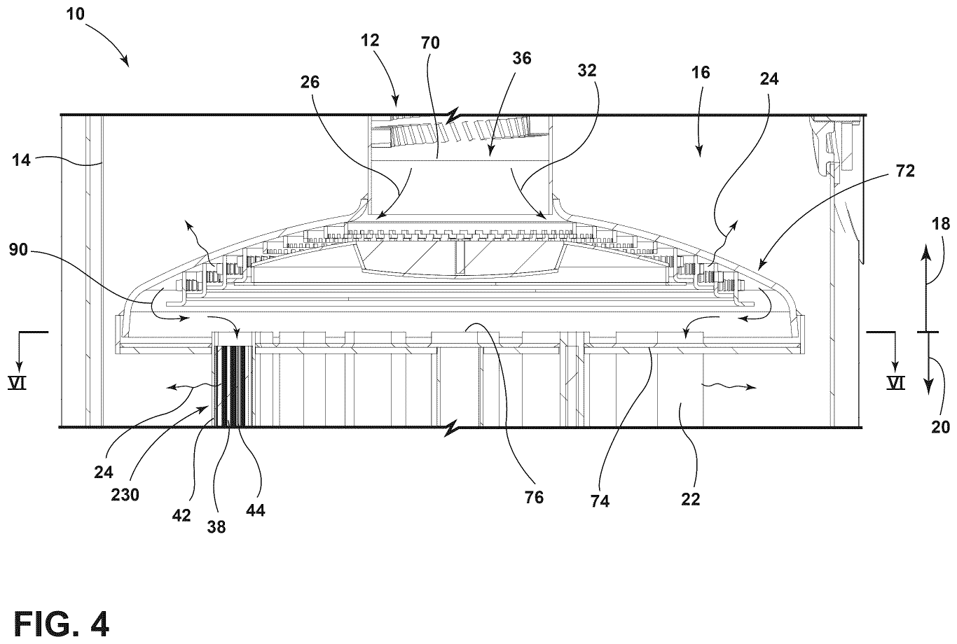

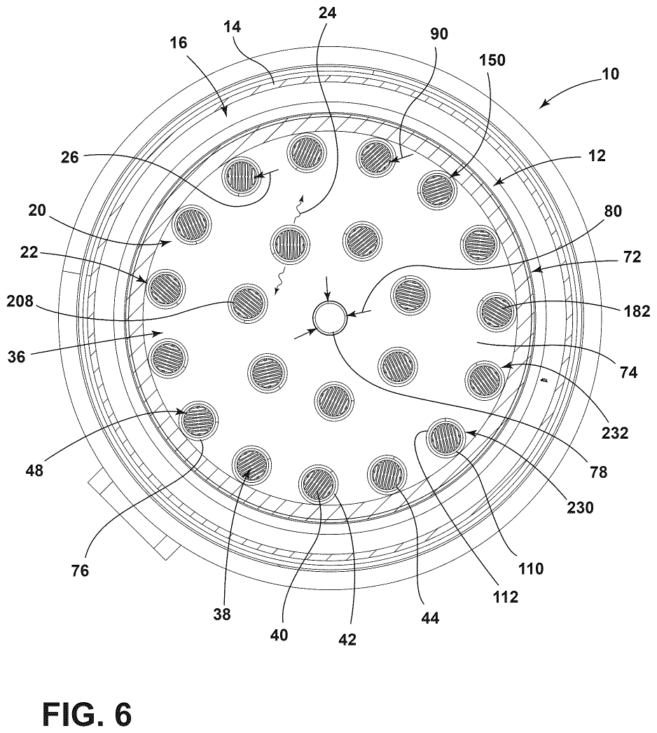

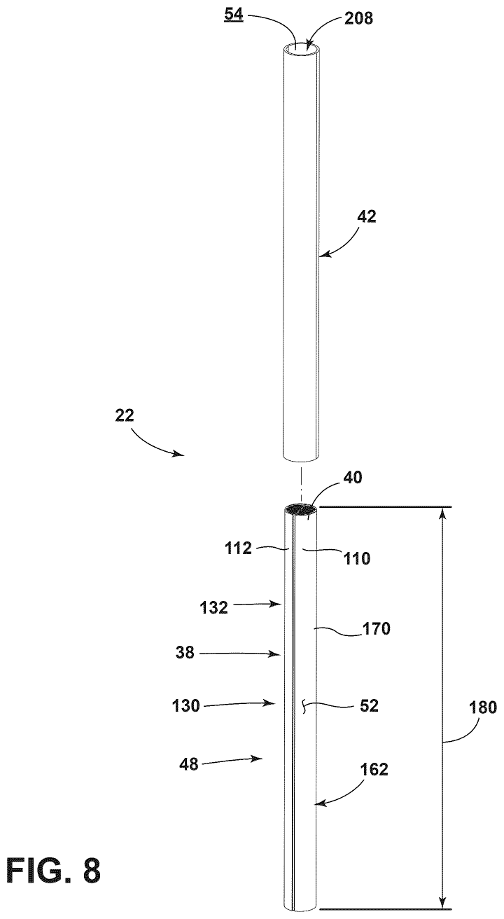

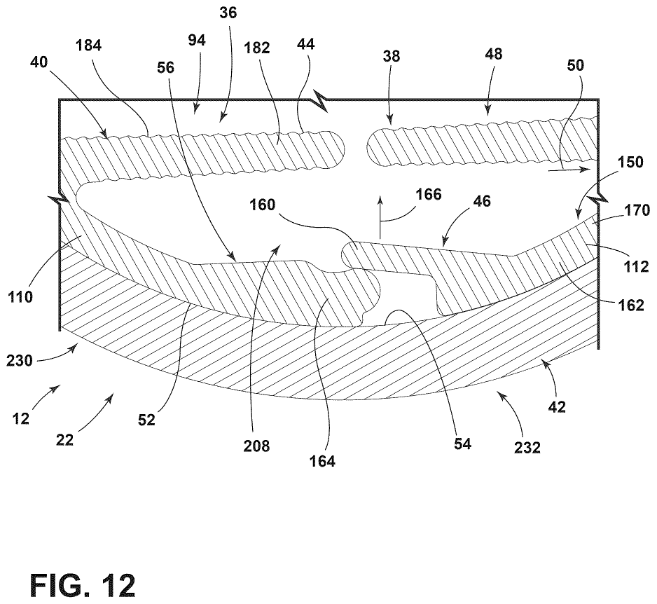

Referring to FIGS. 1-12, reference 10 general refers to a water heater, or water heating appliance, that incorporates a heat exchanger 12 positioned within a reservoir 14 that stores water 16 to be heated. The heat exchanger 12 includes a sensible heat exchange section 18 and a latent heat exchange section 20 that is downstream of the sensible heat exchange section 18. The latent heat exchange section 20 includes a plurality of condensing tubes 22 that extract heat 24 from process air 26 and delivers heat 24 to the water 16 to be heated within the reservoir 14.

According to the various aspects of the device, as exemplified in FIGS. 1-12, the condensing water heating appliance 10, typically in the form of a single-pass condensing water heater 10, includes the reservoir 14 that stores the water 16 to be heated. A heater 28, such as a combustion chamber, and blower 30 (both shown schematically in FIG. 1) deliver heated process air 32 into an airflow inlet 34 positioned at an end of the reservoir 14. A heat exchanger 12 is attached to the airflow inlet 34 and extends through the reservoir 14. The airflow inlet 34 provides access for the heated process air 32 to move through an airflow path 36 of the heat exchanger 12. The heat exchanger 12 includes the sensible heat exchange section 18 of the airflow path 36 that is attached to the airflow inlet 34. The sensible heat exchange section 18 extends through and is in thermal communication with the reservoir 14. The latent heat exchange section 20 of the airflow path 36 is positioned downstream of the sensible heat exchange section 18.

The latent heat exchange section 20 includes a plurality of condensing tubes 22 that are in thermal communication with the reservoir 14. Each condensing tube 22 of the plurality of condensing tubes 22 includes an outer sleeve 42 and a multi-part core 38 that is made up of a plurality of inserts 40. The plurality of inserts 40 define heat exchange obstructions 44 within the structure of the inserts 40. The plurality of inserts 40 are positioned within the outer sleeve 42. Each insert 40 includes a lever portion 46 at a first edge 114 of each insert 40 and a biasing portion 56 at a second edge 116 of each insert 40 that opposes the first edge 114. The lever portion 46 of a first insert 110 of the plurality of inserts 40 respectively engages the biasing portion 56 of an adjacent insert 118 of the plurality of inserts 40 to define an engaged position 48 of the plurality of inserts 40. Typically, the multi-part core 38 can be made up of two separate inserts 40. As discussed herein, the multi-part core 38 can be made up of three or more inserts 40.

The biasing portions 56 of the plurality of inserts 40 operate to deflect the lever portions 46 of the plurality of inserts 40, respectively. This deflection within the outer sleeve 42 operates to generate an outward biasing force 50 that biases an outer surface 52 of each insert 40 of the plurality inserts 40 against an inner surface 54 of the outer sleeve 42. This biasing force 50 substantially eliminates gaps between the plurality of inserts 40 and the outer sleeve 42. By eliminating gaps, the heated process air 32 is directed through the plurality of heat exchange obstructions 44 of each condensing tube 22. Contemporaneously, this heated process air 32 is prevented from traveling between the inserts 40 and the outer sleeve 42 where the heated process air 32 may avoid interaction with the plurality of heat exchange obstructions 44. By directing the heated process air 32 through the obstructions 44, large amounts of heat 24 can be transferred from the heated process air 32, through the obstructions 44 of the condensing tubes 22, and into the water 16 to be heated within the reservoir 14.

Referring again to FIGS. 1-12, the heat exchanger 12 for the water heating appliance 10 includes a flue tube 70 that is attached to the airflow inlet 34 of the reservoir 14. The flue tube 70 extends to a heat exchange structure 72 that incorporates a plurality of heat exchange fins 182 or other heat conductive airflow obstructions 44 to extract heat 24 from heated process air 32 and deliver this heat 24 into the water 16 to be heated within the reservoir 14. The heated process air 32 moves from the flue tube 70, through the heat exchange structure 72, and to a distribution plate 74. This distribution plate 74 includes a plurality of apertures 76 that correspond to the condensing tubes 22 of the latent heat exchange section 20. The distribution plate 74 also includes a drain aperture 78 for collecting condensate 80 that may form in the heat exchange structure 72. Through this configuration, the heated process air 32 leaving the heat exchange structure 72 is directed through the plurality of condensing tubes 22 via the distribution plate 74. Contemporaneously, any condensate 80 formed within the heat exchange structure 72 is directed away from the apertures 76 and the condensing tubes 22 to not impede the movement of the process air 26 into the condensing tubes 22.

The heat exchanger 12 for the water heating appliance 10, typically in the form of a single-pass heat exchanger 12, includes the sensible heat exchange section 18 that includes the flue tube 70 and the heat exchange structure 72. In this portion of the heat exchanger 12, it is typical that the temperature of the heated process air 32 decreases due to the extraction of a portion of the heat 24 from the heated process air 32. This heat 24 is delivered into the water 16 to be heated within the reservoir 14. The heated process air 32 leaving the heat exchange structure 72 has a lower temperature, but a temperature that is typically above the dewpoint of the process air 26 to define cooled process air 90. This cooled process air 90, which contains a significant amount of humidity due to the combustion of fuel within the burner, is directed into the condensing tubes 22 of the latent heat exchange section 20.

Within the condensing tubes 22, heat 24 is further extracted from the cooled process air 90 within the condensing tubes 22. This heat 24 is transferred through the heat exchange obstructions 44 of the inserts 40, through the outer sleeve 42, and into the water 16 to be heated within the reservoir 14 of the water heating appliance 10. As this additional amount of heat 24 is extracted by the condensing tubes 22, the temperature of the cooled process air 90 falls below the dewpoint. When this occurs, humidity within the cooled process air 90 undergoes a phase change from a gaseous vapor state to a condensed liquid state. This liquid condensate 80 is collected and delivered through the condensing tubes 22 and to a condensate pan 92 or other collector of condensate 80 within the water heating appliance 10. As described herein, this phase change of the humidity within the cooled process air 90 from the gaseous state to the liquid state releases a significant amount of heat 24 that is transferred into the water 16 to be heated within the reservoir 14.

Due to the desire for efficiency in the process of extracting heat 24 from the heated process air 32, it is useful to direct the cooled process air 90 leaving the heat exchange structure 72 through the central area 94 of the condensing tubes 22 and between the heat exchange obstructions 44. By preventing the cooled process air 90 from moving between the inserts 40 and the outer sleeve 42. This cooled process air 90, which typically originates as gases that are the byproduct of a combustion process, generally contains moisture. If this cooled process air 90 is able to reside between the inserts 40 and the outer sleeve 42, the condensate 80 that is formed as a result of this moisture can have a corrosive effect on the steel material of the outer sleeve 42. The inserts 40 are typically made from aluminum, which does not have the same corrosive potential as the cooled process air 90 moves therethrough, as compared to the steel of the outer sleeve 42. Because the combustion gases that make up the cooled process air 90 can have a galvanic corrosion potential between the steel material of the outer sleeve 42 and the aluminum material of the inserts 40, it is useful to incorporate the inserts 40 to keep the cooled process air 90 separate from the steel outer sleeve 42. At the same time, the aluminum inserts provide for sufficient transfer of heat 24 from the cooled process air 90 and to the water 16 that surrounds the condensing tubes 22. The steel outer sleeve 42 also provides for the transfer of heat 24 from the cooled process air 90 to the water 16, and also provides structural support and reinforcement to the condensing tubes 22. Through this configuration, heat 24 is efficiently extracted from the cooled process air 90. As the heat 24 is extracted by the inserts 40 of the condensing tubes 22, the condensation effect described herein occurs within the cooled process air 90. This condensation effect results in the extraction of large amounts of heat 24 that is then transferred into the water 16 to be heated within the reservoir 14. As discussed herein, the outward biasing force 50 generated by the interaction of the inserts 40 and the outer sleeve 42 eliminates gaps or substantially eliminates gaps between the inserts 40 and the outer sleeve 42 where the cooled process air 90 may avoid the heat exchange obstructions 44.

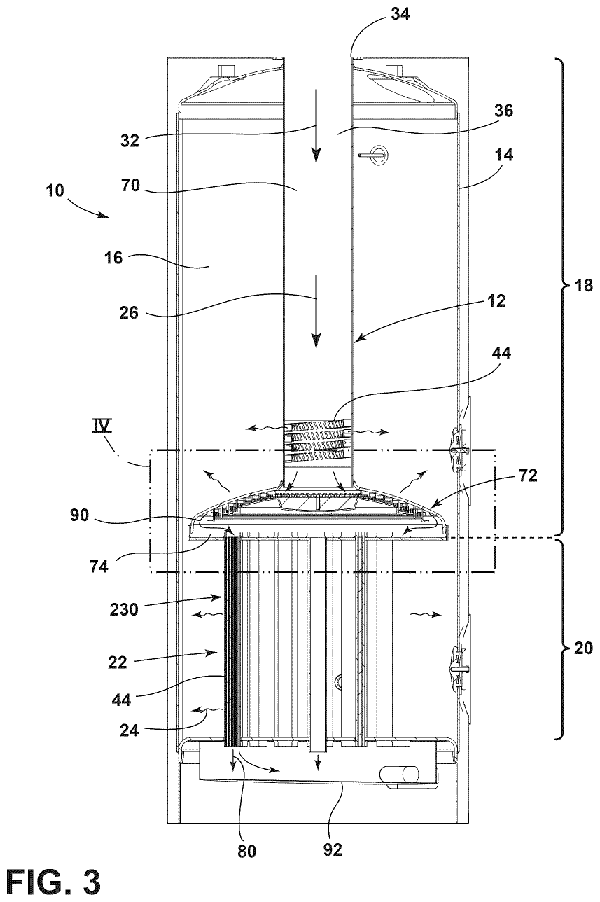

Referring now to FIGS. 3-12, the plurality of inserts 40 typically include a first insert 110 and a second insert 112, where the first insert 110 and the second insert 112 interact with one another to form the engaged position 48. In the engaged position 48, the first edge 114 of the first insert 110 engages the second edge 116 of the second insert 112, and the second edge 116 of the first insert 110 engages the first edge 114 of the second insert 112. As described herein, the lever portion 46 is defined within the first edge 114 of each insert 40 and the biasing portion 56 is defined within the second edge 116 of the inserts 40. In the engaged position 48, each lever portion 46 of the various inserts 40 engages a biasing portion 56 of an adjacent insert 118.

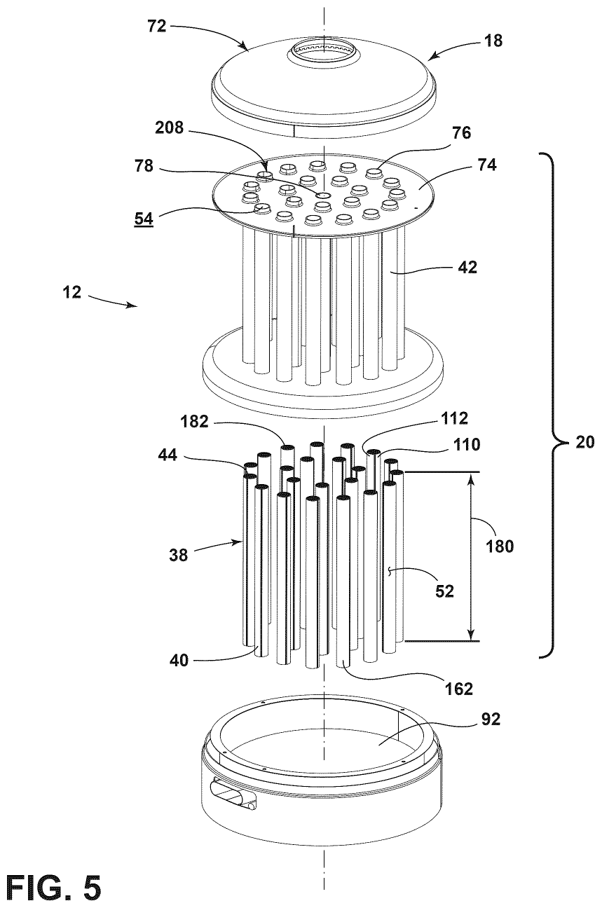

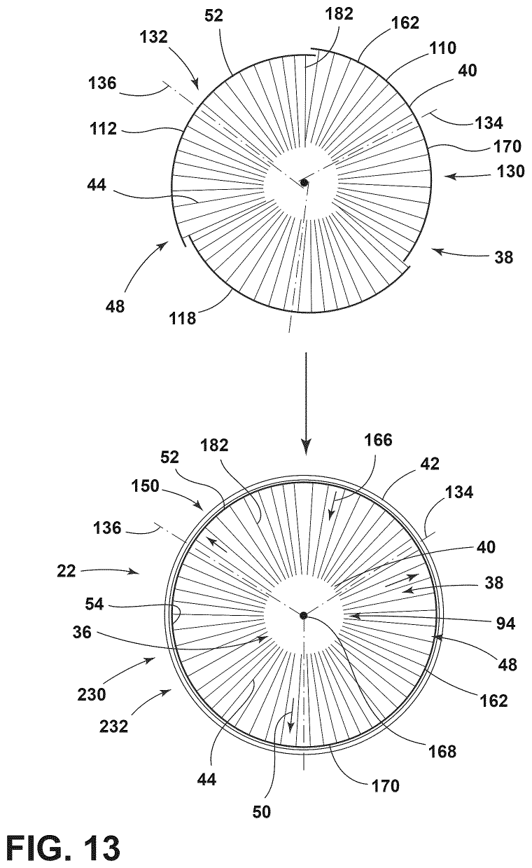

As illustrated in FIGS. 5-13, the condensing tubes 22 include the first insert 110 and the second insert 112. It is contemplated that, in certain aspects of the device, a condensing tube 22 may include three or more inserts 40 that engage with one another within the outer sleeve 42, as shown schematically in FIG. 13. In designs of the device, including three or more inserts 40, each insert 40, as described herein, includes the lever portion 46 of the first edge 114 and the biasing portion 56 at the second edge 116. Each lever portion 46 engages an adjacent biasing portion 56, and each biasing portion 56 engages an adjacent lever portion 46. Accordingly, whether there are two inserts 40, or more than two inserts 40, the principles and design configurations described herein regarding the outward biasing force 50 are consistent throughout condensing tube designs having a plurality of inserts 40.

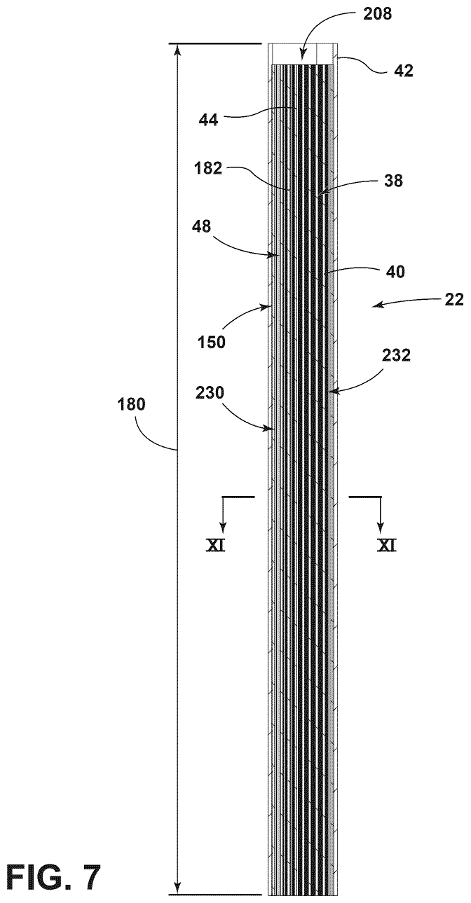

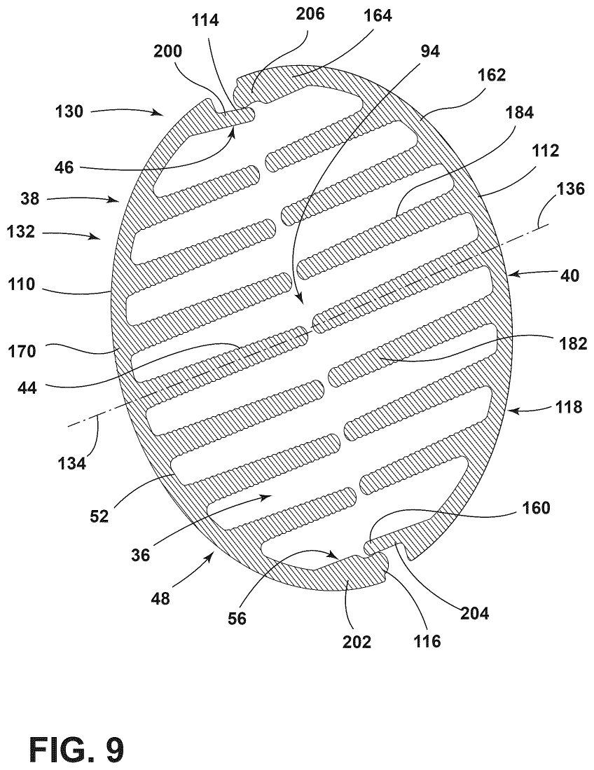

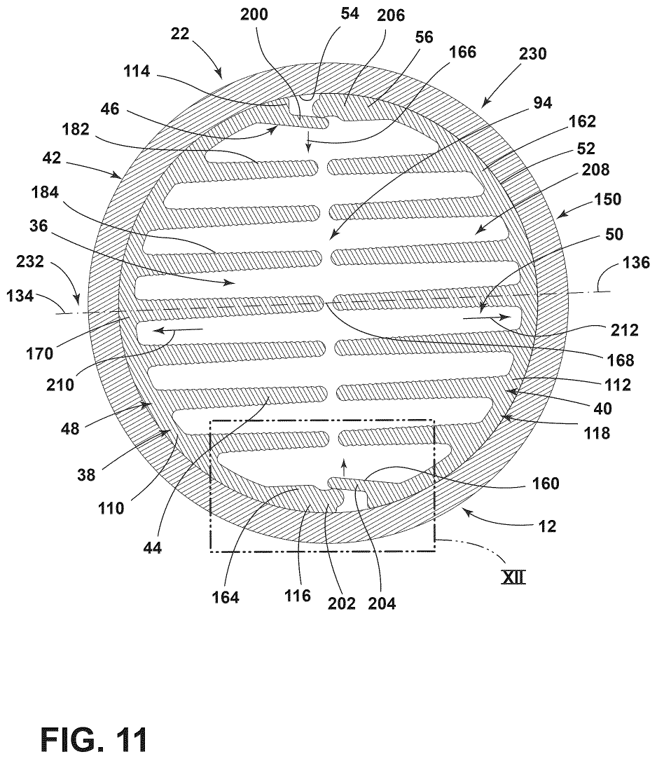

Referring now to FIGS. 7-12, where the plurality of inserts 40 are in the engaged position 48, and distal from, or outside of, the outer sleeve 42, the plurality of inserts 40 define an eccentric configuration 130. This eccentric configuration 130 can also be described as an oblong, oval, or other non-circular configuration. Additionally, the inserts 40 can be positioned in an offset position 132 such that a first central plane 134 of the first insert 110 and a second central plane 136 of the second insert 112 are offset with respect to one another when in the engaged position 48 distal from the outer sleeve 42, as shown in FIG. 9. The oblong profile of the inserts 40 in the engaged position 48, as shown in FIG. 9, may be exaggerated. The precise curvature of the eccentric configuration 130 may be closer to the curvature of the circular configuration 150 shown in FIG. 11. It should be understood that FIGS. 9-11 are intended to illustrate that the modulation of the inserts from the eccentric configuration 130 to the cylindrical configuration 150 produces the outward biasing forces 50 that presses the inserts 40 against the inner surface 54 of the outer sleeve 42, as described herein.

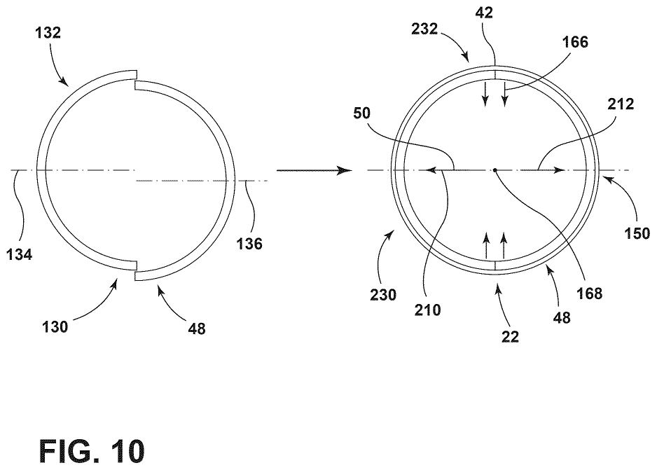

As exemplified schematically in FIG. 10, when the inserts 40 are disposed within the outer sleeve 42, the plurality of inserts 40 remain in the engaged position 48. Additionally, the inserts 40 are modulated into a cylindrical configuration 150 within the cylindrical outer sleeve 42. The modulation of the plurality of inserts 40 from the eccentric configuration 130 to this cylindrical configuration 150 at least partially generates the outward biasing force 50 that presses the inserts 40 against the inner surface 54 of the outer sleeve 42, thereby eliminating gaps therebetween.

Referring again to FIGS. 5-12, the lever portion 46 of each insert 40 includes an elongated flange 160 that extends from an outward wall 162 of each insert 40. The biasing portion 56 of each insert 40 includes an enlarged protrusion 164 defined at the second edge 116 of the outward wall 162 of each insert 40. When the inserts 40 are in the engaged position 48 and positioned inside of the outer sleeve 42, the modulation of the inserts 40 from the eccentric configuration 130 to the cylindrical configuration 150 causes the biasing portion 56, having the enlarged protrusion 164, to bias the lever portion 46 and deflect in an inward direction 166 towards a center 168 of the outer sleeve 42. The inward deflection of the first edge 114 having the lever portion 46 contemporaneously results in a deflection in an outward direction of a central portion 170 of the outward wall 162 of the insert 40. These deflections cause the modulation of the inserts 40 within the outer sleeve 42 from the eccentric configuration 130 to the cylindrical configuration 150. As described herein, this movement of the inserts 40 from the eccentric configuration 130 to the cylindrical configuration 150 generates the outward biasing forces 50 that press the outward wall 162 of each insert 40 against the inner surface 54 of the outer sleeve 42.

Referring again to FIGS. 5-12, the deflection of the inserts 40 from the eccentric configuration 130 to the cylindrical configuration 150 also serves to accommodate tolerances that exist in the material of the aluminum inserts 40 and the steel outer sleeve 42. These tolerances result in dimensional variations in these components. By generating the inward deflection of the lever portion 46 and the outward deflection of the central portion 170, the outward wall 162 of the insert 40 is biased toward and pressed against the inner surface 54 of the outer sleeve 42. Through this pressing of the inserts 40 against the inner surface 54 of the outer sleeve 42, the material of the inserts 40 tends to conform to the shape of the inner surface 54 of the outer sleeve 42. By conforming to the shape of the inner surface 54, these tolerances are accounted for, thereby eliminating gaps and spaces between the inserts 40 and the inner surface 54 of the outer sleeve 42.

According to the various aspects of the device, it is contemplated that the plurality of inserts 40 are made from aluminum which has a thickness that allows the outward wall 162 to be flexed, in a resilient manner, to produce the biasing forces 50 described herein. It is further contemplated that the outer sleeve 42 can be made of a more robust metallic material such as steel, stainless steel, or other similar metallic material that is configured to retain a cylindrical shape during the modulation of the inserts 40 from the eccentric configuration 130 to the cylindrical configuration 150.

In certain aspects of the device, it is contemplated that the inserts 40 can be made of a similar heat conductive material that is effective at transferring heat 24 from the cooled process air 90, through the outer sleeve 42, and into the water 16 to be heated within the reservoir 14. Such materials can include, but are not limited to, aluminum, copper, brass, combinations thereof, and other similar thermally conductive materials. It is also contemplated that the outer sleeve 42 can be made of another rigid material, which is also thermally conductive. Such materials can include, but are not limited to, iron, steel, stainless steel, other steel alloys, other metallic materials, combinations thereof, and other similar rigid and thermally conductive materials.

According to the various aspects of the device, each insert 40 of the plurality of inserts 40 includes the heat exchange obstructions 44. These heat exchange obstructions 44 can be in the form of fins 182, tabs, or other similar protrusions that extend into the central area 94 of the condensing tube 22. These fins 182 are typically configured to extend a length 180 of the insert 40 such that each insert 40 can be extruded to form the configuration of each insert 40. Additionally, each fin 182 can include a textured surface 184 that increases the surface area of each obstruction 44, thereby allowing for greater transfer of heat 24 due to the additional surface area. These textured surfaces 184 can be in the form of ripples, ridges, and other similar textured surface treatments. Typically, these textured surfaces 184 are elongated surfaces that extend the length 180 of each insert 40 so that the textured surface 184 can be extruded along with the remainder of the insert 40.

Referring again to FIGS. 5-12, the latent heat exchange section 20 of the water heating appliance 10 includes at least one condensing tube 22 that is configured to receive process air 26 from a sensible heat exchange section 18 of the water heating appliance 10. The at least one condensing tube 22 of the latent heat exchange section 20 includes a heat conductive first insert 110 having a first lever portion 200 and a first biasing portion 202. Each condensing tube 22 also includes a heat conductive second insert 112 having a second lever portion 204 and a second biasing portion 206. The first insert 110 and the second insert 112 are disposed within the outer sleeve 42 having an interior 208 that receives the first insert 110 and the second insert 112 in the engaged position 48. The second biasing portion 206 engages the first lever portion 200 within the interior 208 of the outer sleeve 42 and generates a first outward biasing force 210 that biases the first insert 110 against the inner surface 54 of the outer sleeve 42. The first biasing portion 202 engages the second lever portion 204 within the interior 208 of the outer sleeve 42 and generates a second outward biasing force 212 that biases the second insert 112 against the inner surface 54 of the outer sleeve 42. The first outward biasing force 210 and the second outward biasing force 212 operates to bias or press the first and second inserts 110, 112 against the inner surface 54 of the outer sleeve 42 to form a substantially continuous seal between the outer sleeve 42 and the first and second inserts 110, 112.

As described herein, this seal prevents the process air 26 from bypassing the heat exchange obstructions 44 of the inserts 40 and moving between the inserts 40 and the outer sleeve 42 which can result in the corrosive effect, as described herein. Rather the seal directs all or substantially all of the process air 26 through the fins 182 or other heat exchange obstructions 44 of these inserts 40 for extracting sufficient amounts of heat 24 from the process air 26 for generating the condensation effect described herein, and delivering the extracted heat 24 into the water 16 to be heated within the reservoir 14.

Referring again to FIGS. 5-12, the first lever portion 200 and the second lever portion 204 each include the elongated flange 160 that extends from the outward wall 162 of the first and second inserts 110, 112, respectively. The first biasing portion 202 and the second biasing portion 206 each include the enlarged protrusion 164 that defines an opposing edge of the outward wall 162 for each of the first and second inserts 110, 112, respectively.

As described herein, the first insert 110 and the second insert 112 in the engaged position 48, distal from the outer sleeve 42, define the eccentric configuration 130. When the first insert 110 and the second insert 112 are disposed within the outer sleeve 42, the inserts 40 are modulated from the eccentric configuration 130 to the cylindrical configuration 150. As described herein, this modulation generates the first outward biasing force 210 and the second outward biasing force 212 that press each of the inserts 40 against the inner surface 54 of the outer sleeve 42.

Referring again to FIGS. 5-12, each condensing tube 22 for the single-pass heat exchanger 12 of the water heating appliance 10 includes the outer sleeve 42 having the inner surface 54 that defines the cylindrical interior 208. The first insert 110 includes the first central plane 134. The second insert 112 includes the second central plane 136. The first and second inserts 110, 112 each include a first edge 114 defining the lever portion 46 and the second edge 116 defining the biasing portion 56. The first and second inserts 110, 112 define the engaged position 48 when the first edge 114 of the first insert 110 engages the second edge 116 of the second insert 112, and the second edge 116 of the first insert 110 engages the first edge 114 of the second insert 112. In this engaged position 48 of the first and second inserts 110, 112, distal from the outer sleeve 42, the inserts 40 form the eccentric configuration 130. This eccentric configuration 130 is further characterized by the first central plane 134 of the first insert 110 and the second central plane 136 of the second insert 112 being in an offset position 132 with respect to one another.

When in the engaged position 48, and the first and second inserts 110, 112 are disposed within the outer sleeve 42, the first and second inserts 110, 112 define an installed state 230. In this installed state 230, the first and second inserts 110, 112 are modulated to define the cylindrical configuration 150 of the first and second inserts 110, 112. This modulation of the first and second inserts 110, 112 from the engaged position 48 distal from the outer sleeve 42 to the installed state 230 within the outer sleeve 42 at least partially biases the first central plane 134 and the second central plane 136 to be in an aligned and co-planar position 232 or a substantially aligned position with respect to one another. In this manner, the installed state 230 generates the outward biasing force 50 that biases the outer surfaces 52 of the first and second inserts 110, 112 against the inner surface 54 of the outer sleeve 42.

As described herein, these outward biasing forces 50 form the substantially continuous seal between the outer sleeve 42 and the first and second inserts 110, 112. The substantially aligned configuration of the first central plane 134 and the second central plane 136 can include a nearly co-planar configuration of these planes 134, 136, where the first central plane 134 and the second central plane 136 are closer to being co-planar in the installed position 230 as compared to the engaged position 48 outside of the outer sleeve 42.

According to the various aspects of the device, each insert 40 when disposed outside of the outer sleeve 42 includes a profile that is generally oblong and not cylindrical. Through this configuration, the modulation of the inserts 40 from the eccentric configuration 130 to the cylindrical configuration 150 can occur, thereby producing the outward biasing force 50 within each of the inserts 40.

In certain aspects of the device, it is contemplated that the inserts 40 can include a generally cylindrical configuration 150. In such a configuration, the elongated flange 160 of each lever portion 46 is positioned to produce the offset position 132 of the first and second inserts 110, 112 when the various inserts 40 are placed in the engaged position 48. As described herein, this offset position 132 is characterized by the first central plane 134 of the first insert 110 being offset from the second central plane 136 of the second insert 112. When the first and second inserts 110, 112 are disposed within the outer sleeve 42, the modulation of the inserts 40 occurs with respect to the elongated flange 160 of the lever portion 46. In this manner, the bending of this elongated flange 160 in an inward direction 166 brings the first insert 110 and the second insert 112 into the aligned and co-planar position 232 and in alignment with one another. Through this modulation of the inserts 40 from the offset position 132 to the aligned and co-planar position 232, the outward biasing force 50 is generated within the outward wall 162 of each insert 40.

Typically, the first insert 110 and the second insert 112 will include an at least slightly oblong contour to the outward wall 162. In this configuration, each of the modulation of the outward wall 162 from the oblong shape to his cylindrical shape, as well as the manipulation of the first and second inserts 110, 112 from the eccentric configuration 130 to the cylindrical configuration 150, produces the outward biasing forces 50 that press the outward walls 162 of each insert 40 against the inner surface 54 of the outer sleeve 42.

According to the various aspects of the device, as exemplified in FIG. 13, where more than two inserts 40 are utilized within each condensing tube 22, the respective central planes of each of the inserts 40 will tend to be out of alignment with one another. When these inserts 40 are placed within the outer sleeve 42, the various inserts 40 will be modulated to the cylindrical configuration 150 such that the central planes of the various inserts 40 tend to intersect at the center 168 of the outer sleeve 42, or substantially near a center 168 of the outer sleeve 42. As described herein, the modulation of the various inserts 40 from the eccentric configuration 130 to the cylindrical configuration 150 at least partially generates the outward biasing force 50 described herein.

As described herein, the heat conductive inserts 40 having the lever portion 46 and the biasing portion 56 operate with one another to cause a deflection of each insert 40 when installed within the outer sleeve 42. This deflection of each insert 40 causes a bending within the outward wall 162 of each insert 40. This bending produces the outward biasing force 50 that biases the outward wall 162 of each insert 40 against the inner surface 54 of the outer sleeve 42. As described herein, by pressing the outward wall 162 of each insert 40 against the inner surface 54 of the outer sleeve 42, gaps and spaces therebetween are minimized or are eliminated. By eliminating these gaps, process air 26 is forced through the interior 208 of each condensing tube 22 so that heat 24 can be extracted by the heat exchange obstructions 44 of the various inserts 40.

According to an aspect of the present disclosure, a single-pass condensing water heater includes a reservoir that stores water to be heated, a heater and a blower that deliver heated process air into an airflow inlet positioned at an end of the reservoir, a sensible heat exchange section of an airflow path that is attached to the airflow inlet and extends through and is in thermal communication with the reservoir, and a latent heat exchange section of the airflow path that is downstream of the sensible heat exchange area. The latent heat exchange section includes a plurality of condensing tubes in thermal communication with the reservoir. Each condensing tube of the plurality of condensing tubes includes an outer sleeve and a plurality of inserts having heat exchange obstructions defined therein. The plurality of inserts are positioned within the outer sleeve. Each insert has a lever portion at a first edge and a biasing portion at a second edge that opposes the first edge. The lever portion of a first insert of the plurality of inserts respectively engages the biasing portion of an adjacent insert of the plurality of inserts. The biasing portions of the plurality of inserts deflect the lever portions of the plurality of inserts, respectively, within the outer sleeve to generate an outward biasing force that biases an outer surface of each insert of the plurality of inserts against an inner surface of the outer sleeve. The outward biasing force substantially eliminates gaps between the plurality of inserts and the outer sleeve to direct the heated process air through the plurality of heat exchange obstructions.

According to another aspect, the plurality of inserts includes a first insert and a second insert.

According to another aspect, the plurality of inserts include aluminum.

According to another aspect, the outer sleeve includes at least one of steel and stainless steel.

According to another aspect, the lever portion is defined within a first edge of each insert of the plurality of inserts.

According to another aspect, the biasing portion is defined within a second edge of each insert of the plurality of inserts.

According to another aspect, the lever portion includes an elongated flange that extends from an outward wall of each insert.

According to another aspect, the biasing portion includes an enlarged protrusion defined at the second edge of the outward wall of each insert.

According to another aspect, the plurality of inserts in an engaged position and distal from the outer sleeve define an eccentric configuration, and the plurality of inserts in the engaged position within the outer sleeve define a cylindrical configuration.

According to another aspect, modulation of the plurality of inserts from the eccentric configuration to the cylindrical configuration at least partially generates the outward biasing force.

According to another aspect, the plurality of condensing tubes transfers heat from the heated process air to the water in the reservoir and condenses humidity within the heated process air to form liquid condensate that collects within the plurality of condensing tubes.

According to another aspect of the present disclosure, a latent heat exchange section of a single-pass condensing water heater includes at least one condensing tube configured to receive heated process air from a sensible heat exchange section. The at least one condensing tube includes a first heat conductive insert having a first lever portion and a first biasing portion, a second heat conductive insert having a second lever portion and a second biasing portion, and an outer sleeve having an interior that receives the first heat conductive insert and the second heat conductive insert. The first biasing portion engages the second lever portion within the interior of the outer sleeve and generates a first outward biasing force that biases the first heat conductive insert against an inner surface of the outer sleeve. The second biasing portion engages the first lever portion within the interior of the outer sleeve and generates a second outward biasing force that biases the second heat conductive insert against the inner surface of the outer sleeve. The first outward biasing force and the second outward biasing force bias the first and second heat conductive inserts against the inner surface to form a substantially continuous seal between the outer sleeve and the first and second heat conductive inserts.

According to another aspect, the first heat conductive insert and the second heat conductive insert include aluminum, and the outer sleeve includes at least one of steel and stainless steel.

According to another aspect, the first lever portion and the second lever portion each includes an elongated flange that extends from an outward wall of the first and second heat conductive inserts, respectively.

According to another aspect, the first biasing portion and the second biasing portion each includes an enlarged protrusion defined at an opposing edge of the outward wall of the first and second heat conductive inserts, respectively.

According to another aspect, the first heat conductive insert and the second heat conductive insert in an engaged position and distal from the outer sleeve define an eccentric configuration, and wherein the first heat conductive insert and the second heat conductive insert in the engaged position within the outer sleeve define a cylindrical configuration.

According to another aspect, modulation of the first heat conductive insert and the second heat conductive insert from the eccentric configuration to the cylindrical configuration at least partially generates the first outward biasing force and the second outward biasing force.

According to another aspect of the present disclosure, a condensing tube for a single-pass heat exchanger of a water heating appliance includes an outer sleeve having an inner surface that defines a cylindrical interior, a first heat conductive insert having a first central plane, and a second heat conductive insert having a second central plane. The first and second heat conductive inserts each include a first edge and a second edge that opposes the first edge. The first and second heat conductive inserts define an engaged position when the first edge of the first heat conductive insert engages the second edge of the second heat conductive insert and the second edge of the first heat conductive insert engages the first edge of the second heat conductive insert. The engaged position of the first and second heat conductive inserts distal from the outer sleeve is defined by an eccentric configuration wherein the first central plane of the first heat conductive insert is offset from the second central plane of the second heat conductive insert. The engaged position of the first and second heat conductive inserts in an installed state within the outer sleeve is defined by a cylindrical configuration of the first and second heat conductive inserts. Modulation of the first and second heat conductive inserts from the engaged position distal from the outer sleeve to the installed state biases the first central plane to be substantially co-planar with the second central plane. Further, the installed state generates an outward biasing force that biases outer surfaces of the first and second heat conductive inserts against the inner surface of the outer sleeve to form a substantially continuous seal between the outer sleeve and the first and second heat conductive inserts.

According to another aspect, the first edges of the first and second heat conductive inserts each includes a lever portion, and the second edges of the first and second heat conductive inserts each includes a biasing portion.

According to another aspect, the lever portions each includes an elongated flange that extends from an outward wall of the first and second heat conductive inserts, respectively, and wherein the biasing portions each includes an enlarged protrusion defined at an opposing edge of the outward wall of the first and second heat conductive inserts, respectively.

It will be understood by one having ordinary skill in the art that construction of the described disclosure and other components is not limited to any specific material. Other exemplary embodiments of the disclosure disclosed herein may be formed from a wide variety of materials, unless described otherwise herein.

What is claimed is:

1. A single-pass condensing water heater comprising:
a reservoir that stores water to be heated;
a heater and a blower that deliver heated process air into an airflow inlet positioned at an end of the reservoir;
a sensible heat exchange section of an airflow path that is attached to the airflow inlet and extends through and is in thermal communication with the reservoir; and
a latent heat exchange section of the airflow path that is downstream of the sensible heat exchange section, the latent heat exchange section including a plurality of condensing tubes in thermal communication with the reservoir, each condensing tube of the plurality of condensing tubes comprising:
an outer sleeve; and
a plurality of inserts having heat exchange obstructions defined therein, the plurality of inserts being positioned within the outer sleeve, each insert having a lever portion at a first edge and a biasing portion at a second edge that opposes the first edge, wherein
the lever portion of a first insert of the plurality of inserts respectively engages the biasing portion of an adjacent insert of the plurality of inserts;
the biasing portions of the plurality of inserts deflect the lever portions of the plurality of inserts, respectively, within the outer sleeve to generate an outward biasing force that biases an outer surface of each insert of the plurality of inserts against an inner surface of the outer sleeve; and
the outward biasing force substantially eliminates gaps between the plurality of inserts and the outer sleeve to direct the heated process air through the plurality of heat exchange obstructions.

2. The single-pass condensing water heater of claim 1, wherein the plurality of inserts includes a first insert and a second insert.

3. The single-pass condensing water heater of claim 1, wherein the plurality of inserts include aluminum.

4. The single-pass condensing water heater of claim 1, wherein the outer sleeve includes at least one of steel and stainless steel.

5. The single-pass condensing water heater of claim 1, wherein the lever portion is defined within a first edge of each insert of the plurality of inserts.

6. The single-pass condensing water heater of claim 5, wherein the biasing portion is defined within a second edge of each insert of the plurality of inserts.

7. The single-pass condensing water heater of claim 6, wherein the lever portion includes an elongated flange that extends from an outward wall of each insert.

8. The single-pass condensing water heater of claim 7, wherein the biasing portion includes an enlarged protrusion defined at the second edge of the outward wall of each insert.

9. The single-pass condensing water heater of claim 1, wherein the plurality of inserts in an engaged position and distal from the outer sleeve define an eccentric configuration, and wherein the plurality of inserts in the engaged position within the outer sleeve define a cylindrical configuration.

10. The single-pass condensing water heater of claim 9, wherein modulation of the plurality of inserts from the eccentric configuration to the cylindrical configuration at least partially generates the outward biasing force.

11. The single-pass condensing water heater of claim 1, wherein the plurality of condensing tubes transfers heat from the heated process air to the water in the reservoir and condenses humidity within the heated process air to form liquid condensate that collects within the plurality of condensing tubes.

12. A latent heat exchange section of a water heater, the latent heat exchanger comprising:
at least one condensing tube configured to receive heated process air from a sensible heat exchange section, the at least one condensing tube comprising:
a first heat conductive insert having a first lever portion and a first biasing portion;
a second heat conductive insert having a second lever portion and a second biasing portion; and
an outer sleeve having an interior that receives the first heat conductive insert and the second heat conductive insert, wherein
the first biasing portion engages the second lever portion within the interior of the outer sleeve and generates a first outward biasing force that biases the first heat conductive insert against an inner surface of the outer sleeve;
the second biasing portion engages the first lever portion within the interior of the outer sleeve and generates a second outward biasing force that biases the second heat conductive insert against the inner surface of the outer sleeve; and
the first outward biasing force and the second outward biasing force bias the first and second heat conductive inserts against the inner surface to form a substantially continuous seal between the outer sleeve and the first and second heat conductive inserts.

13. The latent heat exchange section of claim 12, wherein the first heat conductive insert and the second heat conductive insert include aluminum, and wherein the outer sleeve includes at least one of steel and stainless steel.

14. The latent heat exchange section of claim 12, wherein the first lever portion and the second lever portion each includes an elongated flange that extends from an outward wall of the first and second heat conductive inserts, respectively.

15. The latent heat exchange section of claim 14, wherein the first biasing portion and the second biasing portion each includes an enlarged protrusion defined at an opposing edge of the outward wall of the first and second heat conductive inserts, respectively.

16. The latent heat exchange section of claim 12, wherein the first heat conductive insert and the second heat conductive insert in an engaged position and distal from the outer sleeve define an eccentric configuration, and wherein the first heat conductive insert and the second heat conductive insert in the engaged position within the outer sleeve define a cylindrical configuration.

17. The latent heat exchange section of claim 16, wherein modulation of the first heat conductive insert and the second heat conductive insert from the eccentric configuration to the cylindrical configuration at least partially generates the first outward biasing force and the second outward biasing force.

18. A condensing tube for a heat exchanger of a water heating appliance, the condensing tube comprising:
an outer sleeve having an inner surface that defines a cylindrical interior;
a first heat conductive insert having a first central plane; and
a second heat conductive insert having a second central plane, the first and second heat conductive inserts each including a first edge and a second edge that opposes the first edge; wherein
the first and second heat conductive inserts define an engaged position when the first edge of the first heat conductive insert engages the second edge of the second heat conductive insert and the second edge of the first heat conductive insert engages the first edge of the second heat conductive insert;
the engaged position of the first and second heat conductive inserts distal from the outer sleeve is defined by an eccentric configuration wherein the first central plane of the first heat conductive insert is offset from the second central plane of the second heat conductive insert;
the engaged position of the first and second heat conductive inserts in an installed state within the outer sleeve is defined by a cylindrical configuration of the first and second heat conductive inserts;
modulation of the first and second heat conductive inserts from the engaged position distal from the outer sleeve to the installed state biases the first central plane to be substantially co-planar with the second central plane; and
the installed state generates an outward biasing force that biases outer surfaces of the first and second heat conductive inserts against the inner surface of the outer sleeve to form a substantially continuous seal between the outer sleeve and the first and second heat conductive inserts.

19. The condensing tube of claim 18, wherein the first edges of the first and second heat conductive inserts each includes a lever portion, and wherein the second edges of the first and second heat conductive inserts each includes a biasing portion.

20. The condensing tube of claim 19, wherein the lever portions each includes an elongated flange that extends from an outward wall of the first and second heat conductive inserts, respectively, and wherein the biasing portions each includes an enlarged protrusion defined at an opposing edge of the outward wall of the first and second heat conductive inserts, respectively.
